(19) United States
(12) Patent Application Publication
(10) Pub. No.: US 2013/0308938 A1
(43) Pub. Date: Nov. 21, 2013

(54) OPTICAL COMPONENT, OPTICAL FIBER AMPLIFIER USING THE SAME, AND LASER DEVICE USING THE SAME

(71) Applicant: FUJIKURA LTD., (US)

(72) Inventor: Ryo Sugimoto, Sakura-shi (JP)

(73) Assignee: FUJIKURA LTD., Tokyo (JP)

(21) Appl. No.: 13/846,192

(22) Filed: Mar. 18, 2013

(30) Foreign Application Priority Data
Mar. 27, 2012 (JP) 2012-070786

(51) Int. Cl. H01S 3/067; H04B 10/079

(52) U.S. Cl. CPC H01S 3/06783; H04B 10/07955
USPC 398/38; 359/341.1; 359/341.3

(57) ABSTRACT

An optical component includes: a glass capillary; an optical fiber for light to be measured which is inserted into the through-hole of the glass capillary; at least one optical fiber for leak light which is inserted into the through-hole of the glass capillary; and an output optical fiber having one end connected to one end of the optical fiber for light to be measured, wherein light emitted from the output optical fiber enters into the optical fiber for light to be measured from the one end side thereof, and a part of light that has been emitted from the output optical fiber that does not enter into the optical fiber for light to be measured, that is, leak light enters into the optical fiber for leak light from the one end side thereof.

### TECHNICAL FIELD

The invention relates to an optical component capable of stably extracting leak light, an optical fiber amplifier using the optical component, and a laser device using the optical component.

### BACKGROUND ART

In an optical communication system and a laser processing device, a laser device that amplifies light using pumping light and emits the amplified light is used. In addition, in an optical communication system, an optical fiber amplifier for amplifying signal light using pumping light is used. In some laser devices and optical fiber amplifiers of these types, a feedback control for adjusting the light intensity by monitoring the intensity of the emitted light is performed.

In Japanese Patent No. 3162641, an optical component that separates light for monitoring is described. In this optical component, a light transmissive tube is made to cover between coating layers of respective optical fibers so as to be reinforced, or connection point is covered with light transmissive resin or the like so as to be reinforced. In addition, an optical sensor is provided outside of the tube or resin, and this optical sensor receives leak light from the connection point between the two optical fibers through the tube or resin so that the intensity of light propagating through the two optical fibers is detected.
[Patent Document 1] Japanese Patent 3162641

### SUMMARY OF THE INVENTION

However, when the tube is made to cover between the coating layers of the respective optical fibers in the optical component of Japanese Patent 3162641, a state where the optical fibers with their coating layers removed float in the empty space inside the tube is made. Therefore, this optical component may be sensitive to vibration or the like, and thus the intensity of the leak light may not be stably detected. In addition, also when the connection point is covered with light transmissive resin or the like, the resin is susceptible to temperature, and thus the intensity of the leak light may not be stably detected. Further, when the intensity of the leak light is high, the resin or the like may absorb a part of the leak light and thus generate heat, which may lead to burnout.

Therefore, an object of the invention is to provide an optical component capable of stably extracting leak light, an optical fiber amplifier using the optical component, and a laser device using the optical component.

In order to achieve the object, an optical component of the invention includes: a glass capillary formed with plural through-holes from a first end surface to a second end surface; an optical fiber for light to be measured that is inserted into one of the through-holes from the second end surface side to the first end surface side of the glass capillary, and that has one end fixed to the glass capillary; at least one optical fiber for leak light that is inserted into a through-hole different from the through-hole into which the optical fiber for light to be measured is inserted from the second end surface side to the first end surface side of the glass capillary, and that has one end fixed to the glass capillary; and an output optical fiber having one end connected to the one end of the optical fiber for light to be measured, wherein light emitted from the output optical fiber enters into the optical fiber for light to be measured from the one end side thereof, and a part of light that has been emitted from the output optical fiber and that does not enter into the optical fiber for light to be measured, that is, leak light enters into the optical fiber for leak light from the one end side thereof.

With this optical component, leak light that has not entered into the optical fiber for light to be measured from the output optical fiber can be extracted by the optical fiber for leak light. In addition, the end of the optical fiber for light to be measured and the end of the optical fiber for leak light are respectively fixed to the glass capillary. Therefore, even when an impact is applied from the outside, or when the environmental temperature increases, the relative positions of the ends of the respective optical fibers are remained fixed. Therefore, the optical component of the invention can stably extract leak light. By using leak light that has been thus extracted as light for monitoring, the intensity of light that has entered into the optical fiber for light to be measured can be accurately obtained. In addition, since a glass capillary is used, heat generation due to light absorption is small, and thus high intensity leak light can be monitored.

Further, the end of the optical fiber for leak light is preferably positioned away from the end of the optical fiber for light to be measured toward the second end surface side of the glass capillary.

As described above, the end of the optical fiber for leak light is set back from the end of the optical fiber for light to be measured toward the light traveling direction side. Therefore, even when leak light propagates at an angle from the first end surface side to the second end side of the glass capillary, the leak light propagating at an angle can enter into the optical fiber for leak light. Therefore, more leak light can enter into the optical fiber for leak light, and more leak light can be extracted.

In this case, the equation: r≦d tan θ is preferably satisfied, where d is a distance along the longitudinal direction of the glass capillary from the one end of the output optical fiber to the one end of the optical fiber for leak light, r is the shortest distance from a portion of a core of the optical fiber for light to be measured that is closest to the optical fiber for leak light to a portion of a core of the optical fiber for leak light that is farthest from the optical fiber for light to be measured, and θ is a divergence angle of light output from the output optical fiber.

When this relative equation is satisfied, leak light can be received by entire surface of the core of the optical fiber for leak light into which light enters. Therefore, leak light can be extracted more efficiently.

In addition, when the end of the optical fiber for leak light is positioned away from the end of the optical fiber for light to be measured toward the second end surface side of the glass capillary as described above, it is preferable that a glass rod that is connected to the end of the optical fiber for leak light is provided inside the through-hole, and the leak light enters into the optical fiber for leak light through the glass rod.

When leak light enters into the glass capillary, the amount of leak light propagating from the glass capillary to the glass rod provided inside the through-hole is more than the amount of leak light propagating from the glass capillary to an empty space in the through-hole. Thus, with such a configuration, leak light can propagate to the end of the optical fiber for leak light. Therefore, more leak light can enter into the optical fiber for leak light.

Further, the refractive index of the glass rod is preferably not less than the refractive index of the glass capillary. In this case, leak light that has entered into the glass capillary can propagate to the glass rod.

In addition, the refractive index of the core of the optical fiber for leak light is preferably not less than the refractive index of the glass rod. In this case, leak light that has entered into the glass rod can efficiently enter into the optical fiber for leak light.

Further, it is preferable that the optical fiber for leak light is provided in a plurality, and the respective optical fibers for leak light are arranged in the glass capillary at symmetrical positions against a center axis of the optical fiber for light to be measured.

When the optical fiber for light to be measured is surrounded by the plural optical fibers for leak light, change of the amount of leak light extracted by the whole of the optical fibers for leak light can be prevented even if the output optical fiber and the optical fiber for light to be measured misalign. In particular, if the number of the optical fibers for leak light is three or more, change of the amount of leak light extracted by the whole of the optical fibers for leak light can be prevented even if there is misalignment as described above and regardless of the direction of the misalignment.

In addition, an optical fiber amplifier of the invention includes: a pumping light source emitting pumping light; an amplification optical fiber having a core doped with active elements to be pumped by the pumping light and a clad into which the pumping light enters; any one of the optical components described above having the output optical fiber into which light emitted from the amplification optical fiber enters; and a light detection unit that detects the intensity of the leak light emitted from the optical fiber for leak light, wherein the intensity of the pumping light emitted from the pumping light source is adjusted according to the intensity of the leak light detected by the light detection unit.

With such an optical fiber amplifier, an amplification level of light is adjusted based on the intensity of leak light. In addition, in the optical component, leak light that has not entered into the optical fiber for light to be measured from the output optical fiber can be stably extracted from the optical fiber for leak light. Therefore, the light detection unit can stably detect the intensity of leak light. As described above, the intensity of leak light to be measured is stable. Therefore, stable feedback can be provided for the intensity of light emitted from the pumping light source, and thus stable amplification of light is possible.

In addition, a laser device of the invention includes: any one of the optical components described above; a light source causing light to enter into the output optical fiber; and a light detection unit that detects an intensity of the leak light emitted from the optical fiber for leak light, wherein an intensity of the light emitted from the light source is adjusted according to the intensity of the leak light detected by the light detection unit.

In the optical component, leak light that has not entered into the optical fiber for light to be measured from the output optical fiber can be stably extracted from the optical fibers for leak light. Therefore, the light detection unit can stably detect the intensity of leak light. As described above, the intensity of leak light to be measured is stable. Therefore, stable feedback can be provided for the intensity of light emitted from the light source, and thus stable output light can be emitted from the optical fiber for light to be measured.

According to the invention, an optical component capable of stably extracting leak light, an optical fiber amplifier using the optical component and a laser device using the optical component are provided as described above.

### BRIEF DESCRIPTION OF THE DRAWINGS

FIG. 1 is a view showing an optical component according to a first embodiment of an optical component of the invention.

FIGS. 2A and 2B are cross-section views of a glass capillary shown in FIG. 1.

FIG. 3 is a cross-section view of an optical component according to a second embodiment of an optical component of the invention.

FIG. 4 is a view showing an embodiment of a laser device according to the invention.

FIG. 5 is a view showing a concrete example of the laser device shown in FIG. 4.

FIG. 6 is a view showing a relationship between the intensity of output from the light source of the first example and the intensity of leak light.

FIG. 7 is a view showing a temperature dependency of a relationship between the intensity of output from the light source of the first example and the intensity of leak light.

FIG. 8 is a view showing a relationship between the intensity of output from the light source of the first and second examples and the intensity of leak light.

FIG. 9 is a view showing a relationship between the intensity of output from the light source of the third example and the intensity of leak light.

### EMBODIMENT OF THE INVENTION

Suitable embodiments of an optical component, an optical fiber amplifier using the optical component, and a laser device using the optical component according to the invention will be described in detail hereinafter referring to the attached drawings.

### (1) First Embodiment of Optical Component

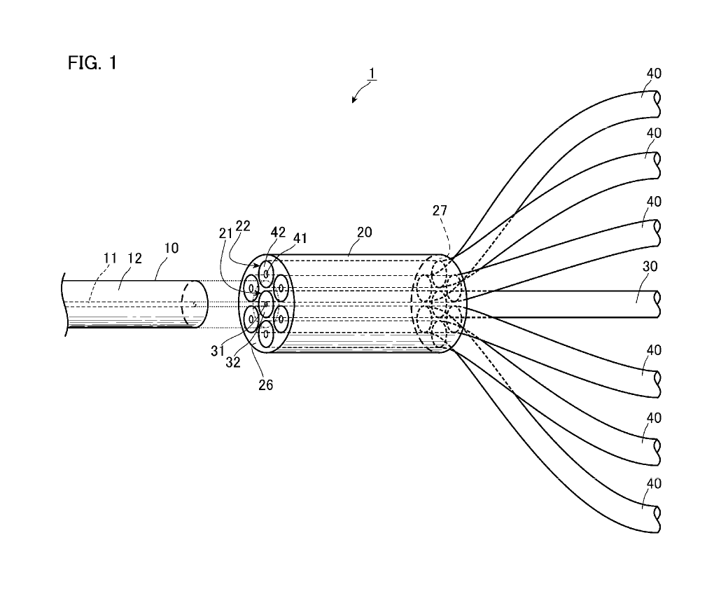

FIG. 1 is a view showing an optical component according to this embodiment. As shown in FIG. 1, the optical component 1 of this embodiment includes: an output optical fiber 10 that emits light; a glass capillary 20 formed with plural through-holes; an optical fiber for light to be measured 30 that is inserted into a through-hole of the glass capillary 20; and plural optical fibers for leak light 40 respectively inserted into the other through-holes of the glass capillary 20, as main components. Note that the optical component 1 is shown in a state where the output optical fiber 10 and the glass capillary 20 are separated in FIG. 1 for easy understanding.

The output optical fiber 10 includes a core 11 and a clad 12 that surrounds the outer circumference surface of the core 11 without any gap. The core 11 is configured to have a larger refractive index than the refractive index of the clad 12. The diameter of the core 11 is not particularly limited, but may be 13 μm, for example. The outer diameter of the clad 12 is not particularly limited, but may be 460 μm.

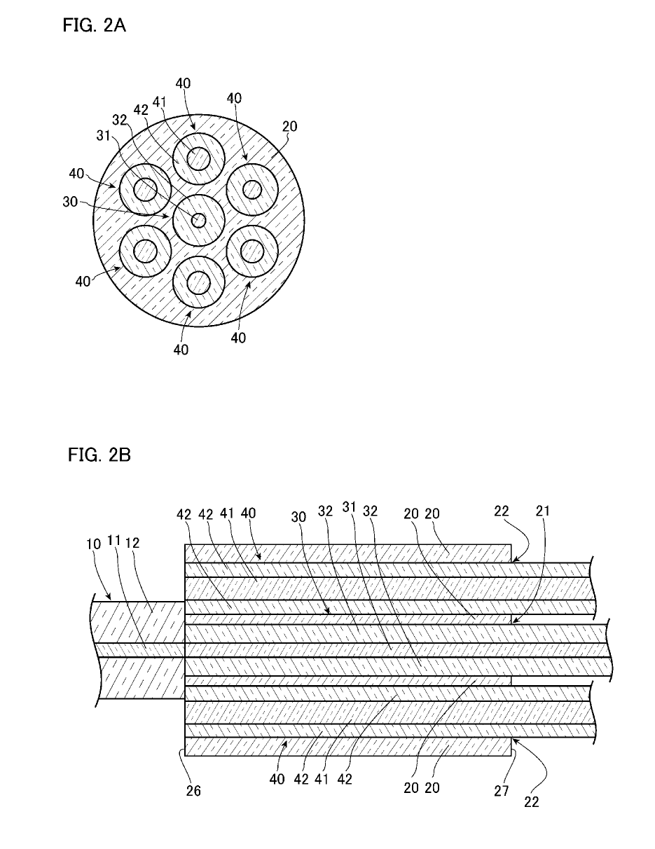

FIG. 2 is a cross-section view of the glass capillary shown in FIG. 1. Specifically, FIG. 2A is a cross-section view in a direction vertical to the longitudinal direction of the glass capillary 20, and FIG. 2B is a cross-section view along the longitudinal direction of the glass capillary 20.

As shown in FIGS. 1 and 2, the outer shape of the glass capillary 20 is a cylindrical shape, and is formed with plural through-holes from a first end surface 26 to a second end surface 27 on the other side. In this embodiment, one through-hole 21 is formed along the center axis of the glass capillary 20, and plural through-holes 22 are formed to surround this through-hole 21. These plural through-holes 22 are formed at symmetrical positions against the center axis of the glass capillary 20. Specifically, the plural through-holes 22 are formed in such a manner that in the cross-section vertical to the longitudinal direction of the glass capillary 20, the centers of the respective through-holes 22 are arranged on a circle having its center on the center of the through-hole 21 at equal intervals. The glass capillary 20 is made of pure silica without any dopant, for example.

The optical fiber for light to be measured 30 includes a core 31 and a clad 32 that surrounds the outer circumference surface of the core 31 without any gap. The core 31 is configured to have a larger refractive index than the clad 32 and to have a refractive index equal to that of the core 11 of the output optical fiber 10, for example. The diameter of the core 31 is not particularly limited, but may be equal to that of the core 11 of the output optical fiber 10, for example. The outer diameter of the clad 32 may be equal to the inner diameter of the through-hole 21 formed along the center axis of the glass capillary 20, and may be 125 μm, for example.

The number of the optical fibers for leak light 40 is identical to the number of the plural through-holes 22 surrounding the through-hole 21 formed along the center axis of the glass capillary 20. The respective optical fibers for leak light 40 are configured to have identical configuration to each other, and each of them includes a core 41 and a clad 42 that surrounds the outer circumference of the core 41 without any gap. The core 41 is configured to have a larger refractive index than the clad 42 and to have a refractive index equal to that of the core 11 of the output optical fiber 10, for example. The diameter of the core 41 is not particularly limited, but may be 50 μm, for example. The outer diameter of the clad may be equal to the inner diameter of the plural through-holes 22 surrounding the through-hole 21 formed along the center axis of the glass capillary 20, and may be 125 μm, for example.

As shown in FIGS. 1 and 2, the optical fiber for light to be measured 30 is inserted into the through-hole 21 formed along the center axis of the glass capillary 20 from the second end surface 27 side to the first end surface 26 side. One end of the optical fiber for light to be measured 30 is fixed to the glass capillary 20 by fusion while the one end is made to be flush with the first end surface 26 of the glass capillary 20. The respective optical fibers for leak light 40 face in a direction identical to the optical fiber for light to be measured 30, and inserted into the respective through-holes 22 from the second end surface 27 side to the first end surface 26 side. One ends of the respective optical fibers for leak light 40 are fixed to the glass capillary 20 by fusion while the one ends are made to be flush with the first end surface 26 of the glass capillary 20.

As described above, the plural through-holes 22 surround the through-hole 21 formed along the center axis of the glass capillary 20, and are formed at symmetrical positions against the center axis of the glass capillary 20. Therefore, the respective optical fibers for leak light 40 inserted into these through-holes 22 are arranged in the glass capillary 20 at symmetrical positions against the center axis of the optical fiber for light to be measured 30 inserted into the center through-hole 21. Specifically, the plural optical fibers for leak light 40 are arranged in such a manner that in the cross-section vertical to the longitudinal direction of the glass capillary 20, the centers of the respective optical fibers for leak light 40 are positioned on a circle having its center on the center of the optical fiber for light to be measured 30 at equal intervals.

In order to fix the one end of the optical fiber for light to be measured 30 and the one ends of the optical fibers for leak light 40 to the glass capillary 20, a glass capillary formed with: the through-hole 21 into which the optical fiber for light to be measured 30 is inserted and which has an inner diameter slightly larger than the outer diameter of the clad 32 of the optical fiber for light to be measured 30; and the through-holes 22 into which the optical fibers for leak light 40 are inserted and which have the inner diameter slightly larger than the clads 42 of the optical fibers for leak light 40 is firstly provided. The size of the inner diameter of the respective through-holes of this glass capillary may be 130 μm, for example, when the outer diameter of the clad 32 of the optical fiber for light to be measured 30 and the outer diameter of the clads 42 of the optical fibers for leak light 40 are both 125 μm. Then, into the respective through-holes of the provided glass capillary, the optical fiber for light to be measured 30 and the optical fibers for leak light 40 are respectively inserted, and the glass capillary is heated to reduce its diameter. Thus, the inner diameter of the through-holes of the glass capillary become identical to the outer diameter of the clad 32 of the optical fiber for light to be measured 30 and the outer diameter of the clads 42 of the optical fibers for leak light 40, and the optical fiber for light to be measured 30 and the respective optical fibers for leak light 40 are fixed to the glass capillary 20. Then, polishing is performed so that the one end of the optical fiber for light to be measured 30 and the one ends of the respective optical fibers for leak light 40 can be flush with the first end surface 26 of the glass capillary 20. The one end of the optical fiber for light to be measured 30 and the one ends of the respective optical fibers for leak light 40 that are thus made to be flush with the first end surface 26 of the glass capillary 20 are fixed to the glass capillary 20.

In addition, as shown in FIG. 1, one end of the output optical fiber 10 is connected to the one end of the optical fiber for light to be measured 30 in such a manner that light emitted from the core 11 of the output optical fiber 10 enters into the core 31 of the optical fiber for light to be measured 30. The connection may be done by fusion. Note that the output optical fiber 10 and the optical fiber for light to be measured 30 are connected not to make an ideal state where all light emitted from the core 11 of the output optical fiber 10 enters into the core 31 of the optical fiber for light to be measured 30, but to make a state where the core 11 of the output optical fiber 10 and the core 31 of the optical fiber for light to be measured 30 are slightly misaligned, or a state where the connection section between the core 11 of the output optical fiber 10 and the core 31 of the optical fiber for light to be measured 30 is slightly distorted, for example. With such connection, a part of light emitted from the output optical fiber 10 does not enter into the core 31 of the optical fiber for light to be measured 30 and becomes leak light. For example, when the output optical fiber 10 is fused to the optical fiber for light to be measured 30 using an oxyhydrogen burner or by electric discharge, a part of light emitted from the core 11 of the output optical fiber 10 usually becomes leak light even by accurate fusion. Note that since the clad 12 of the output optical fiber 10 has an outer diameter larger than the clad 32 of the optical fiber for light to be measured 30, the clad 12 of the output optical fiber 10 is fused to at least the first end surface 26 of the glass capillary 20 in addition to the clad 32 of the optical fiber for light to be measured 30.

The optical component 1 is configured as described above. Each of the output optical fiber 10, the optical fiber for light to be measured 30, and the optical fibers for leak light 40 may have a coating layer that coats the outer circumference surface of its clad at a position away from the glass capillary 20, which is not particularly shown.

Next, the optical operation of the optical component 1 and the effect thereof will be described.

When light is emitted from the end of the output optical fiber 10, most of the light enters into the core 31 of the optical fiber for light to be measured 30. The light that has entered into the core 31 propagates through the core 31. On the other hand, light that has not entered into the core 31 and has become leak light propagates through the inside of the glass capillary 20 and enters into the cores 41 of the respective optical fibers for leak light 40. The light that has entered into the respective cores 41 propagates through the cores 41.

At this time, the relative positions of the end of the optical fiber for light to be measured 30 and the ends of the optical fibers for leak light 40 are fixed by the glass capillary 20. Therefore, even if vibration or temperature change occurs when light is emitted from the output optical fiber 10, change of the amount of leak light entering into the optical fibers for leak light 40 can be prevented. Therefore, leak light can be stably extracted.

In addition, in this embodiment, the plural optical fibers for leak light 40 are provided, and the respective optical fibers for leak light 40 are arranged in the glass capillary 20 at symmetrical positions against the center axis of the optical fiber for light to be measured 30 inserted into the center through-hole 21 as described above. Therefore, when the core 11 of the output optical fiber 10 and the core 31 of the optical fiber for light to be measured 30 are misaligned, it can be prevented that the amount of leak light entering into whole of the plural optical fibers for leak light 40 changes depending on the direction of the misalignment. Specifically, when the core 11 of the output optical fiber 10 misaligns in one radial direction of the first end surface 26 of the glass capillary 20, more leak light enters into optical fibers for leak light 40 positioned in the direction. However, the amount of leak light entering into the optical fibers for leak light 40 arranged in the radial direction of the first end surface 26 that is opposite to the one direction become smaller. Thus, the amounts of leak light are canceled between the optical fibers for leak light 40 into which more leak light enters and the optical fibers for leak light 40 into which less light enters so that change of the amount of leak light entering into whole of the plural optical fibers for leak light 40 can be prevented. Therefore, variability of products can be prevented and leak light can be stably extracted.

### (2) Second Embodiment of Optical Component

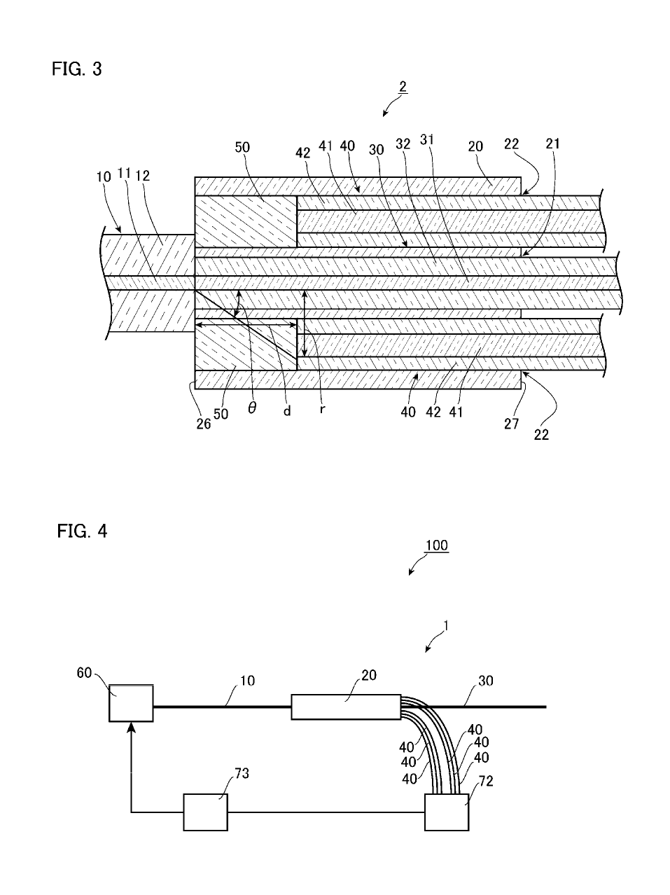

Next, a second embodiment of the invention will be described in detail referring to FIG. 3. Here, components that are identical or similar to those in the first embodiment are indicated by the same reference numerals and the same explanation will not be repeated unless otherwise particularly mentioned.

FIG. 3 is a cross-section view of an optical component according to this embodiment, and a view corresponding to FIG. 2B of the first embodiment. As shown in FIG. 3, the optical component 2 of this embodiment is different from the optical component 1 of the first embodiment in a point that the ends of the respective optical fibers for leak light 40 are positioned away from the end of the optical fiber for light to be measured 30 toward the second end surface 27 side of the glass capillary 20. The one ends of the optical fibers for leak light 40 are fixed to the glass capillary 20 while the one ends are not made to be flush with the first end surface 26 of the glass capillary 20 and are inserted into the through-holes 22.

On the end of the respective optical fibers for leak light 40, glass rods 50 are connected. The respective glass rods 50 have a cylindrical shape and are made to have a diameter similar to the outer diameter of the clads 42 of the optical fibers for leak light 40. Then, the respective glass rods 50 are made to have one end surfaces that are flush with the first end surface 26 of the glass capillary 20, and have the other end surfaces connected to the ends of the optical fibers for leak light 40. In this state, the respective glass rods 50 are fixed to the glass capillary 20 inside the respective through-holes.

Note that in this embodiment, it is preferable that the refractive index of the glass rods 50 is not less than the refractive index of the glass capillary 20. It is also preferable that the refractive index of the cores 41 of the optical fibers for leak light 40 are not less than the refractive index of the glass rods 50.

As shown in FIG. 3, a distance from the one end of the optical fiber for light to be measured 30 to the one ends of the optical fibers for leak light 40 along the longitudinal direction of the glass capillary 20 is indicated by d, and the shortest distance from a portion of the core 31 of the optical fiber for light to be measured 30 that is closest to the optical fibers for leak light 40 to portions of the cores 41 of the optical fibers for leak light 40 that are farthest to the optical fiber for light to be measured 30 is indicated by r. Further, the divergence angle when leak light propagates at an angle from the first end surface 26 side to the second end surface 27 side of the glass capillary 20 is indicated by θ.

In this case, whole of the one ends of the cores 41 of the respective optical fibers for leak light 40 can be irradiated when the following equation (1) is satisfied.

When the equation 1 is satisfied, whole of the one ends of the cores 41 can receive leak light. Therefore, leak light can be extracted more efficiently.

With the optical component 2, the ends of the optical fibers for leak light 40 are lower than the end of the optical fiber for light to be measured 30 toward the light traveling direction side. Therefore, even when leak light propagates at an angle from the first end surface 26 side to the second end surface 27 side of the glass capillary 20, this leak light propagating at an angle can enter into the cores 41 of the respective optical fibers for leak light 40. Therefore, more leak light can enter into the optical fibers for leak light 40, and more leak light can be extracted.

In addition, since the glass rods 50 are connected to the ends of the optical fibers for leak light 40 inside the through-holes 22 in this embodiment, leak light enters into the cores 41 of the respective optical fibers for leak light 40 through the glass rods 50. Therefore, more leak light can propagate to the ends of the optical fibers for leak light 40 than in a case where the glass rods 50 are not provided and leak light propagates from the glass capillary 20 to the ends of the optical fibers for leak light 40 through the empty space inside the through-holes 22. In particular, if the refractive index of the glass rods 50 is set to be not less than the refractive index of the glass capillary 20 as described above, leak light entering into the glass capillary 20 can propagate to the glass rods 50 more efficiently. Further, if the refractive index of the cores 41 of the respective optical fibers for leak light 40 is set to be not less than the refractive index of the glass rods 50 as described above, light propagating to the glass rods 50 can propagate to the cores 41 of the respective optical fibers for leak light 40 more efficiently.

### (3) Embodiment of Laser Device

Next, a laser device using the above-described optical component will be described.

FIG. 4 is a view showing a laser device according to this embodiment. As shown in FIG. 4, the laser device 100 of this embodiment includes: a light source 60; the optical component 1 of the above-described embodiment connected to the light source 60; a light detection unit 72 connected to the optical fibers for leak light 40; and a control unit 73, as main components.

The light source 60 is not particularly limited as long as it emits laser light, and may be configured by a semiconductor laser device or a fiber laser device, for example. Fiber laser devices of fabry-perot type, fibering type, and a MO-PA (Master Oscillator Power Amplifier) type may be used as this fiber laser device.

To a light emit section of the light source 60, the end of the output optical fiber 10 of the optical component 1 opposite to the side connected to the optical fiber for light to be measured 30 is connected, and the light emitted from the light source 60 enters into the core 11 of the output optical fiber 10.

The ends of the respective optical fibers for leak light 40 opposite to the side fixed to the glass capillary 20 are connected to the light detection unit 72. The light detection unit 72 includes a light receiving elements such as photodiodes that receive light emitted from the respective optical fibers for leak light 40 and converts the light to voltages, and is configured to output an electric signal corresponding to the intensity of leak light received by the light receiving elements.

The light detection unit 72 is electrically connected to the control unit 73. The control unit 73 is configured in such a manner that an electric signal output from the light detection unit 72 enters into the control unit 73, and that a control signal is generated based on the entered electric signal.

The control unit 73 is electrically connected to the light source 60, and the intensity of light emitted from the light source 60 is controlled by the control signal output from the control unit 73.

In the laser device 100, when light having a predetermined intensity is emitted from the light source 60, this light propagates from the output optical fiber 10 to the optical fiber for light to be measured 30 and then emitted from the optical fiber for light to be measured 30. At this time, in the optical component 1, leak light that has not entered into the optical fiber for light to be measured 30 from the output optical fiber 10 enters into the respective optical fibers for leak light 40, and the light that has entered into the respective optical fibers for leak light 40 propagates to the light detection unit 72.

The light detection unit 72 detects the intensity of the received leak light, outputs an electric signal corresponding to the intensity of the leak light. The control unit 73 receives the electric signal. The control unit 73 then generates a control signal based on the electric signal. When the control unit 73 determines that the intensity of leak light is large based on the received electric signal, and thus the intensity of light entering into the optical fiber for light to be measured 30 is large, for example, it generates a control signal to lower the intensity of light emitted from the light source 60. On the other hand, when the control unit 73 determines that the intensity of leak light is small based on the received electric signal, and thus the intensity of light entering into the optical fiber for light to be measured 30 is small, it generates a control signal to increase the intensity of light emitted from the light source 60. Then, the control unit 73 outputs the generated control signal to the light source 60.

The light source 60 adjust the intensity of light to be emitted according to the control light received from the control unit 73

According to the laser device of this embodiment, leak light that does not enter into the optical fiber for light to be measured 30 from the output optical fiber 10 can be stably extracted from the optical fibers for leak light 40 in the optical component 1. Therefore, the intensity of leak light can be stably detected by the light detection unit 72. As described above, the intensity of detected leak light is stable. Therefore, stable feedback can be provided for the intensity of light emitted from the light source 60, and thus stable output light can be emitted from the optical fiber for light to be measured 30.

### (4) Concrete Example of Laser Device

Next, a concrete example of the laser device 100 will be described.

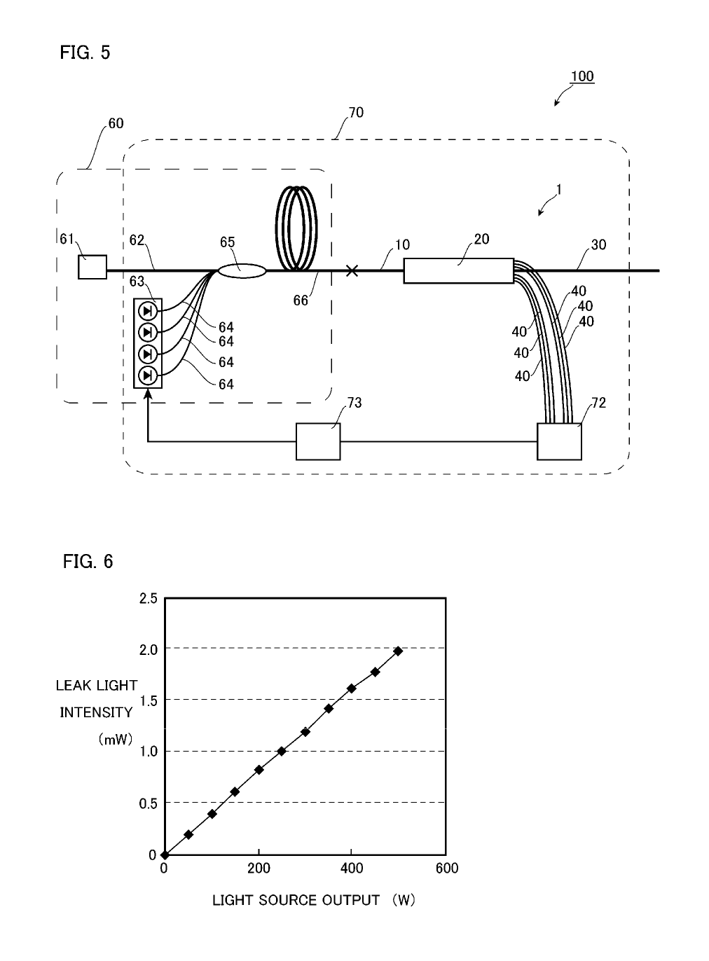

In this concrete example, a case where the light source 60 is a MO-PA type fiber laser device will be described. FIG. 5 is a view showing the concrete example of the laser device shown in FIG. 4. As described above, the light source 60 is a MO-PA type fiber laser device including: a seed light source 61 that emits seed light; a pumping light source 63 that emits pumping light; an amplification optical fiber 66; and an optical coupler 65 that makes seed light emitted from the seed light source 61 and pumping light emitted from the pumping light source 63 enter into the amplification optical fiber 66, as main components. Note that, a part of the optical fibers for leak light 40 is not shown in FIG. 5, for easy understanding.

This laser device 100 may be grasped as a MO-PA type fiber laser device constituted of the optical fiber amplifier 70 enclosed by a dashed line and the seed light source 61 in FIG. 5. In this case, the optical fiber amplifier 70 includes: the pumping light source 63 that emits pumping light; the amplification optical fiber 66 having a core doped with active elements to be pumped by the pumping light and a clad into which the pumping light enters; the optical component 1 of the above-described embodiment having the output optical fiber 10 into which light emitted from the amplification optical fiber 66 enters; the light detection unit 72 connected to the optical fibers for leak light 40; and the control unit, as main components.

The seed light source 61 may be configured by a laser light source including a laser diode or a fiber laser device of fabry-perot type or fibering type, for example. The seed light source 61 is connected to a seed light optical fiber 62. Therefore, seed light emitted from the seed light source 61 propagates through the core of the seed light optical fiber 62.

The pumping light source 63 includes plural laser diodes (LD), and to the respective LDs, respective pumping light optical fibers 64 are connected. Therefore, pumping light emitted from the respective LDs propagates through the pumping light optical fibers 64.

The amplification optical fiber 66 is formed as a double clad fiber including a core, a clad surrounding the core without any gap, and an outer clad coating the clad, for example. The refractive index of the clad is lower than the refractive index of the core, and the refractive index of the outer clad is even lower than the refractive index of the clad. The core is doped with active elements such as ytterbium (Yb) that is pumped by pumping light emitted from the pumping light source 63, for example. Rare earth elements may be used as such active elements, and as rare earth elements, thulium (Tm), cerium (Ce), neodymium (Nd), europium (Eu), erbium (Er), and the like may be used other than above-described Yb. In addition, as active elements, bismuth (Bi), chrome (Cr), and the like may be used other than rare earth elements.

In the optical coupler 65, the core of the seed light optical fiber 62 is connected to the core of the amplification optical fiber 66, and the cores of the pumping light optical fibers 64 are connected to the clad of the amplification optical fiber 66.

In addition, the amplification optical fiber 66 has an end on the side opposite to the optical coupler 65 side connected to the output optical fiber 10, and is configured in such a manner that light emitted from the core of the amplification optical fiber 66 enters into the core 11 of the output optical fiber 10.

Further, the control unit 73 is electrically connected to the pumping light source 63 of the light source 60, and is configured to control the intensity of pumping light to be emitted using a control signal of the control unit 73.

In the laser device 100, first, seed light having a predetermined wavelength is emitted from the seed light source 61, and pumping light having a predetermined wavelength is emitted from the respective laser diodes of the pumping light source 63. The seed light emitted from the seed light source 61 propagates through the core of the seed light optical fiber 62, enters into the core of the amplification optical fiber 66 in the optical coupler 65, and propagates through the core of the amplification optical fiber 66. In addition, the pumping light emitted from the pumping light source 63 propagates through the pumping light optical fiber 64, enters into the clad of the amplification optical fiber 66 in the optical coupler 65, and propagates mainly through the clad of the amplification optical fiber 66.

In the amplification optical fiber 66, the pumping light passing through the core pumps active elements, the pumped active elements cause a stimulated emission due to the seed light, and the seed light is amplified by the stimulated emission. The seed light is emitted from the amplification optical fiber 66 as output light.

The output light emitted from the core of the amplification optical fiber 66 enters into the core 11 of the output optical fiber 10, propagates through the core 11, and enters into the core 31 of the optical fiber for light to be measured 30 from the core 11 of the output optical fiber 10. Then, similarly to the above description of the laser device, the intensity of leak light extracted by the respective optical fibers for leak light 40 is detected by the light detection unit 72, the control unit 73 receives an electric signal based on the intensity of the leak light output from the light detection unit 72, and generates and outputs a control signal.

The control signal output from the control unit 73 is input to the pumping light source 63. The pumping light source 63 adjusts the intensity of the pumping light to be emitted based on this control signal.

Therefore, in the optical fiber amplifier 70, an amplification level of light is adjusted based on the intensity of leak light. Since the extraction of leak light is stable in the optical component 1, the optical fiber amplifier 70 can stably amplifies light.

Although the optical component 1 of the first embodiment is used as an optical component in the description of the laser device 100 and the optical fiber amplifier 70, the optical component 2 of the second embodiment may be used.

Although the invention has been described above by reference to the above-described embodiments as examples, the invention is not limited thereto.

For example, in the above-described optical component of the second embodiment, the glass rods 50 are provided inside the through-holes 22, but the glass rods 50 may not necessarily be provided.

In addition, in the above embodiment, the plural optical fibers for leak light 40 are used, but single or plural optical fiber(s) for leak light 40 may be provided. When the plural optical fibers for leak light 40 are used, the respective optical fibers for leak light 40 may not necessarily be arranged in the glass capillary 20 at symmetrical positions against the center axis of the optical fiber for light to be measured 30.

In addition, in the concrete example of the laser device described above, the amplification optical fiber 66 is connected to the output optical fiber 10, but the output optical fiber 10 and the amplification optical fiber 66 may be configured similarly, and the amplification optical fiber 66 and the output optical fiber 10 may be formed integrally.

### EXAMPLES

The invention will be more concretely described with examples hereinafter, but the invention is not limited thereto.

### First Example

A cylindrical glass capillary having an outer diameter of 800 μm and the length of 10 mm was provided. In this glass capillary, two through-holes having a diameter of 130 μm are formed from a first end surface to a second end surface, and the center-to-center distance of the respective through-holes was 200 μm. As an optical fiber for propagation of light to be measured, an optical fiber that has a core having a diameter of 13 μm and a clad having an outer diameter of 125 μm was provided. As an optical fiber for leak light, an optical fiber that has a core having a diameter of 50 μm and a clad having an outer diameter of 125 μm was provided. As an output optical fiber, an optical fiber with a core having a diameter of 13 μm and a clad having an outer diameter of 460 μm was provided.

Next, an end of the optical fiber for light to be measured was inserted into one through-hole of the capillary, and an end of the optical fiber for leak light was inserted into the other through-hole of the capillary. At this time, the ends of the respective optical fibers were formed to be flush with one end of the capillary. Then the capillary was heated by an oxyhydrogen burner so that the end of the optical fiber for light to be measured and the end of the optical fiber for leak light were fixed to the capillary. Next, the core of the output optical fiber and the core of the optical fiber for light to be measured were aligned and the output optical fiber was fused to the optical fiber for light to be measured. Which means that the amount of leak light can be small when light propagates from the core of the output optical fiber to the core of the optical fiber for light to be measured. At this time, since the outer diameter of the clad of the output optical fiber is larger than the outer diameter of the clad of the optical fiber for light to be measured as described above, the clad of the output optical fiber also fused to the capillary. An optical component was thus manufactured.

In addition, the end of the optical fiber for leak light on the side that was not fixed to the capillary was optically connected to a photodiode so that the intensity of light emitted from the optical fibers for leak light can be detected by the photodiode.

Next, light enters into the output optical fiber and light is emitted from the core of the output optical fiber to the core of the optical fiber for light to be measured. Then, by changing the intensity of light that enters into the output optical fiber, the intensity of light emitted from the output optical fiber was changed. The intensity of leak light detected by the photodiode at this time is shown in FIG. 6.

As shown in FIG. 6, with the configuration of the optical component of this example, it was confirmed that the intensity of leak light extracted by the optical fiber for leak light increases according to the intensity of light emitted from the output optical fiber.

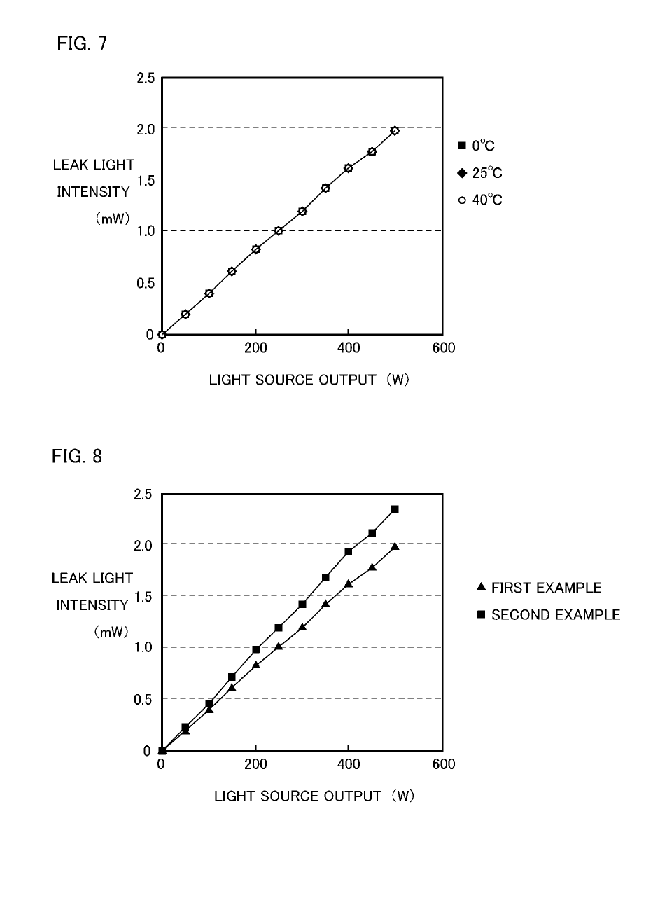

Next, light was emitted from the core of the output optical fiber to the core of the optical fiber for light to be measured similarly to that described above while changing the temperature of the environment around this optical component to 0° C., 25° C., and 40° C., and the intensity of light to be emitted was changed. The intensity of leak light detected by the photodiode at this time is shown in FIG. 7.

As shown in FIG. 7, positions of plots for the respective temperatures were not substantially changed. Thus, it was confirmed that with the optical component of this example, leak light can be stably extracted regardless of environmental temperature. Therefore, it was confirmed that with the optical component of this invention, leak light can be appropriately extracted by the optical fiber for leak light.

### Second Example

The end of an optical fiber for leak light was set back 500 μm in a through-hole of a capillary. In addition, a glass rod having a diameter similar to the outer diameter of the clad of the optical fiber for leak light, and having a length of 500 μm was inserted into this through-hole. In a state where the glass rod and the optical fiber for leak light are connected, the glass rod and the optical fibers for leak light were fixed to the capillary. An optical component is manufactured in the configuration similar to the first example except for the point described above.

Next, light was emitted from the core of the output optical fiber to the core of the optical fiber for light to be measured, and the intensity of the light to be emitted was changed similarly to the first example. The intensity of leak light detected by the photodiode at this time is shown in FIG. 8.

It was confirmed that leak light can be extracted even more efficiently according to the optical component of this example as shown in FIG. 8.

### Third Example

Next, a glass capillary similarly to the glass capillary of the first embodiment except for a point that a through-hole was formed along the center axis and six through-holes were formed around the through-hole along this center axis was prepared. The size of the respective through-holes formed in this glass capillary was similar to the through-holes formed in the glass capillary of the first example, and the center-to-center distance of the six respective through-holes formed around the through-hole along the center axis and the through-hole formed along the center axis was 200 μm. Further, the six respective through-holes formed around the through-hole along the center axis were respectively formed to be symmetry against the center axis.

Then, similarly to the first example, an optical fiber for propagation of light to be measured that is similar to the first example was inserted into the center through-hole and was fixed to the glass capillary similarly to the first example. In addition, into the six respective through-holes formed around the through-hole along the center axis, optical fibers for leak light similar to the first example were inserted and were respectively fixed to the glass capillary similarly to the first example.

Then, the output optical fiber were fused to the optical fiber for light to be measured similarly to the first example except for a point that the center axis of the output optical fiber and the center axis of the optical fiber for light to be measured were offset by 2 μm in the diameter direction of the capillary. An optical component was thus manufactured. Note that this offset is not necessary in the invention, but was purposely provided in this example in order to confirm the effect of the invention.

In addition, the ends of the optical fibers for leak light on the side that are not fixed to the capillary were optically connected individually to photodiodes so that the intensity of light emitted from the optical fibers for leak light can be detected individually by the photodiodes.

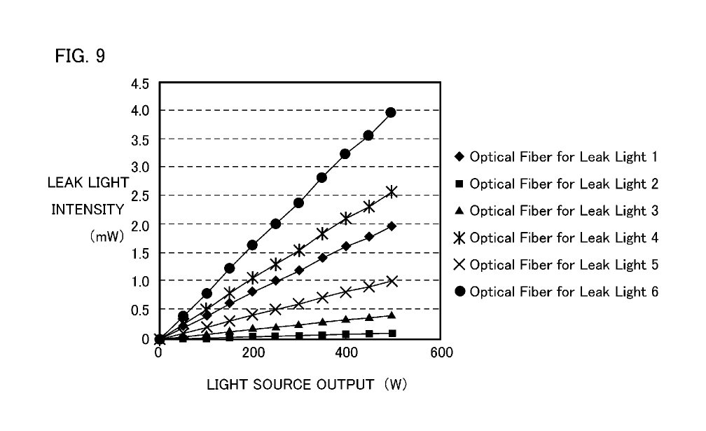

Next, similarly to the first example, light was emitted from the core of the output optical fiber to the core of the optical fiber for light to be measured, and the intensity of the light to be emitted was changed similarly to the first example. The intensity of leak light detected by the respective photodiodes at this time is shown in FIG. 9.

From FIG. 9, it can be seen that the above-described offset made the propagation direction of leak light anisotropic. However, since the optical fibers for leak light were arranged symmetrically against the center axis, extracted amounts of leak light are canceled between optical fibers for leak light into which less leak light enters and optical fibers for leak light into which more leak light enters due to the offset. Thus, it was confirmed that the anisotropy of the propagation direction of leak light was prevented by detecting the intensity of leak light from the whole of the optical fibers for leak light. Therefore, it is considered that an effect of variation of leak light due to offset can be prevented, and then the amount of light entering into the optical fiber for light to be measured can be stably measured.

### INDUSTRIAL APPLICABILITY

According to the invention, an optical component capable of stably extracting leak light, an optical fiber amplifier using the optical component, and a laser device using the optical component are provided, and they can be applied to an optical communication system and a laser processing device.

1. An optical component comprising: a glass capillary formed with plural through-holes from a first end surface to a second end surface; an optical fiber for light to be measured that is inserted into one of the through-holes from the second end surface side to the first end surface side of the glass capillary, and that has one end fixed to the glass capillary; at least one optical fiber for leak light that is inserted into a through-hole different from the through-hole into which the optical fiber for light to be measured is inserted from the second end surface side to the first end surface side of the glass capillary, and that has one end fixed to the glass capillary; and an output optical fiber having one end connected to the one end of the optical fiber for light to be measured, wherein light emitted from the output optical fiber enters into the optical fiber for light to be measured from the one end side thereof, and a part of light that has been emitted from the output optical fiber and that does not enter into the optical fiber for light to be measured, that is, leak light enters into the optical fiber for leak light from the one end side thereof.

2. The optical component according to claim 1, wherein the end of the optical fiber for leak light is positioned away from the one end of the optical fiber for light to be measured toward the second end surface side of the glass capillary.

3. The optical component according to claim 1 or 2, wherein r≦d tan θ is satisfied where d is a distance along the longitudinal direction of the glass capillary from the one end of the output optical fiber to the one end of the optical fiber for leak light, r is the shortest distance from a portion of a core of the optical fiber for light to be measured that is closest to the optical fiber for leak light to a portion of a core of the optical fiber for leak light that is farthest from the optical fiber for light to be measured, and θ is a divergence angle of light output from the output optical fiber.

4. The optical component according to claim 2, wherein a glass rod that is connected to the end of the optical fiber for leak light is provided inside the through-hole, and the leak light enters into the optical fiber for leak light through the glass rod.

5. The optical component according to claim 4, wherein a refractive index of the glass rod is not less than a refractive index of the glass capillary.

6. The optical component according to claim 4 or 5, wherein a refractive index of the core of the optical fiber for leak light is not less than the refractive index of the glass rod.

7. The optical component according to any one of claims 1, 2, 4 and 5, wherein the optical fiber for leak light is provided in a plurality, the respective optical fibers for leak light are arranged in the glass capillary at symmetrical positions against a center axis of the optical fiber for light to be measured.

8. An optical fiber amplifier comprising: a pumping light source emitting pumping light; an amplification optical fiber having a core doped with active elements to be pumped by the pumping light and a clad into which the pumping light enters; the optical component according to any one of claims 1, 2, 4 and 5 having the output optical fiber into which light emitted from the amplification optical fiber enters; and a light detection unit that detects an intensity of the leak light emitted from the optical fiber for leak light, wherein an intensity of the pumping light emitted from the pumping light source is adjusted according to the intensity of the leak light detected by the light detection unit.

9. A laser device comprising: the optical component according to any one of claims 1, 2, 4 and 5; a light source causing light to enter into the output optical fiber; and a light detection unit that detects an intensity of the leak light emitted from the optical fiber for leak light, wherein an intensity of the light emitted from the light source is adjusted according to the intensity of the leak light detected by the light detection unit.
